(19) United States
(12) Patent Application Publication
(10) Pub. No.: US 2025/0079474 A1
(43) Pub. Date: Mar. 6, 2025

(54) Bipolar Plate for Fuel Cell and Method for Manufacturing same, and Fuel Cell

(71) Applicant: Robert Bosch GmbH, Stuttgart (DE)

(72) Inventors: Rongrong Jiang, Shanghai (CN); Xiaogang Hao, Shanghai (CN)

(21) Appl. No.: 18/553,053

(22) PCT Filed: Feb. 24, 2022
(86) PCT No.: PCT/EP2022/054691

§ 371 Date: Sep. 28, 2023

(30) Foreign Application Priority Data
Apr. 7, 2021 (CN) 2021 1037 1534.5

(51) Int. Cl. H01M 8/0228; H01M 8/021; H01M 8/0213; H01M 8/0234; H01M 8/0245

(52) U.S. Cl. CPC H01M 8/0228; H01M 8/021; H01M 8/0213; H01M 8/0234; H01M 8/0245

(57) ABSTRACT

A method for manufacturing a bipolar plate for a fuel cell is disclosed. The method includes (i) using a carboxylic acid solution to treat a surface of a base material or body of the bipolar plate such that a microstructure with a certain roughness forms on the surface, and (ii) rubbing the surface with graphite such that fragments of the graphite fill the microstructure and bind to carboxyl groups in the microstructure. Also disclosed is a bipolar plate for a fuel cell, and a fuel cell including the bipolar plate. Thus, it possible to obtain a fuel cell bipolar plate having a carbon coating with higher attachment strength while simplifying the production process and reducing the production cost.

### TECHNICAL FIELD

The present application relates to the field of fuel cells, in particular to a bipolar plate for a fuel cell and a method for manufacturing same, and a fuel cell comprising the bipolar plate.

### BACKGROUND ART

In order to solve the problems of global warming, air pollution and energy consumption that are becoming more serious by the day, the automotive industry is currently transforming from motor vehicles powered by internal combustion engines to electric vehicles. Of all the types of electric vehicles, those powered by fuel cells are the most prominent. A fuel cell is composed of a membrane electrode assembly (MEA), bipolar plates (BPP), end plates and a clamp, all of these components being fitted together to form a stack. Within the stack, the BPPs and MEA are pressed together to maintain electrical contact. In order to reduce contact resistance and avoid corrosion, the BPP surfaces are generally coated with a carbon coating by a vacuum physical vapour deposition (PVD) method. However, this coating method has the following disadvantages: 1) multiple layers of coating are needed, because the carbon is very difficult to attach to the metal surfaces, and the multiple layers of coating will take up more time and cost more; 2) the entire coating process needs to take place in a vacuum chamber, which will increase the cost and the time taken, and make mass production very difficult.

Furthermore, there are also processes in the prior art whereby a coating is formed on the BPP surface by rubbing graphite against the BPP; however, it is difficult to form a carbon coating having ideal strength on the BPP surface by these processes.

Thus, there is still a need to improve an existing fuel cell bipolar plate and manufacturing method thereof, in order to obtain a carbon coating with high attachment strength while simplifying the production process and reducing production costs.

### SUMMARY OF THE INVENTION

An object of the present application is to overcome the shortcomings of the prior art by providing a bipolar plate for a fuel cell and a method for manufacturing same, and a fuel cell comprising the bipolar plate, which can make fuel cell bipolar plate production simpler and more economical, and increase the carbon coating attachment strength.

To this end, the present application provides a method for manufacturing a bipolar plate for a fuel cell, comprising the following steps:
using a carboxylic acid solution to treat a surface of a base material or body of the bipolar plate, such that a microstructure with a certain roughness forms on the surface; and
rubbing the surface with graphite, such that fragments of the graphite fill the microstructure and bind to carboxyl groups in the microstructure.

According to an embodiment of the present application, the carboxylic acid solution is an aqueous solution of at least one of oxalic acid, formic acid, acetic acid, peroxy acids, ethanedioic acid, malonic acid, benzoic acid, succinic acid, butenedioic acid, phthalic acid and a-naphthaleneacetic acid, and the weight percentage concentration of the carboxylic acid solution is in the range of 5%-60%.

According to an embodiment of the present application, the average value of the roughness of the surface is greater than or equal to 0.1 microns.

According to an embodiment of the present application, the graphite is made into one of a graphite block, a graphite rod and a graphite wheel, and the graphite slides or rolls against the surface of the base material or body of the bipolar plate.

According to an embodiment of the present application, the manufacturing method further comprises covering a part of the surface of the body of the bipolar plate with a protective layer before using the carboxylic acid solution to treat the surface of the body of the bipolar plate, in order to expose a rib on the surface of the body of the bipolar plate; or the manufacturing method further comprises making the bipolar plate from the base material after using the carboxylic acid solution to treat the surface of the base material of the bipolar plate and rubbing with graphite.

According to an embodiment of the present application, the protective layer is one of polyimide, polyamide and polyester.

According to an embodiment of the present application, the carboxylic acid solution and the surface of the base material or body of the bipolar plate undergo a reaction for 10-200 seconds within a temperature range of 20° C.-70° C.

According to an embodiment of the present application, the manufacturing method further comprises a step of drying the treated surface of the base material or body of the bipolar plate within a temperature range of 20° C.-100° C.

A bipolar plate for a fuel cell is further provided, the bipolar plate comprising: a body; and a carbon coating, wherein a surface of the body has a microstructure with a certain roughness that is formed by treatment with a carboxylic acid solution, and the carbon coating is bound to the body via carboxyl groups in the microstructure.

In addition, the present application further provides a fuel cell, wherein the fuel cell comprises the bipolar plate described above.

In the present application, the microstructure with a certain roughness is formed on the body surface of the bipolar plate of the fuel cell by corrosion with the carboxylic acid solution, and the graphite fragments are not only embedded in the microstructure to form the carbon coating but also bind to the carboxyl groups in the microstructure. Thus, the carbon coating formed is able to have higher attachment strength, and the manufacturing method of the present application does not require a vacuum working environment, so the cost is reduced and the time shortened.

### BRIEF DESCRIPTION OF THE DRAWINGS

Exemplary embodiments of the present application are described in detail below with reference to the drawings, but it should be understood that the embodiments described below are merely intended to explain the present application without limiting the scope thereof; in the drawings:

FIG. 1 is a schematic flow chart of the method for manufacturing a bipolar plate for a fuel cell according to an embodiment of the present application.

FIG. 2 is a schematic drawing of step S1 in the method shown in FIG. 1.

FIG. 3 is a schematic drawing of step S2 in the method shown in FIG. 1; and

FIG. 4 is a schematic sectional view of a bipolar plate made by the method shown in FIG. 1.

### DETAILED DESCRIPTION OF THE INVENTION

Preferred embodiments of the present application are described in detail below with reference to examples. However, those skilled in the art should understand that these exemplary embodiments do not imply any limitation on the present application. Moreover, in the absence of conflict, features in the embodiments of the present application may be combined. In the drawings, for the sake of conciseness, other components and steps are omitted, but this does not mean that the fuel cell bipolar plate of the present application cannot include other components, and does not mean that the method for manufacturing the fuel cell bipolar plate of the present application cannot include other steps. It should be understood that the sizes, proportional relationships and quantities of components in the drawings do not limit the present application.

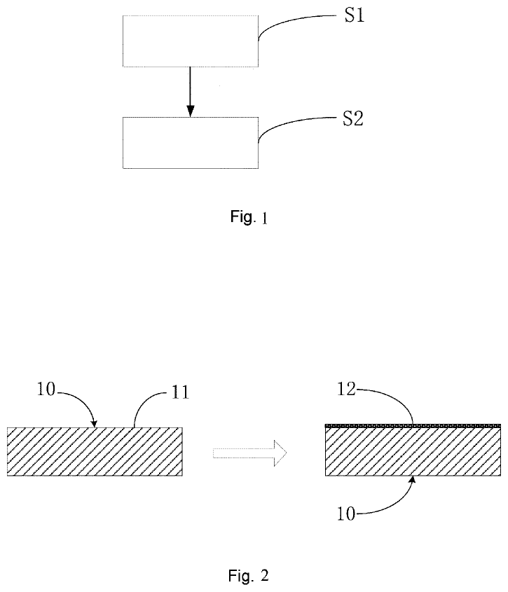

As shown in FIGS. 1-4, the method of the present application for manufacturing a bipolar plate for a fuel cell mainly comprises the following steps:
Step S1: using a carboxylic acid solution to treat (i.e. corrode) a surface 11 of a body 10 of the bipolar plate, such that a microstructure 12 with a certain roughness forms on the surface 11;
step S2: rubbing the surface 11 with graphite 20, such that fragments of the graphite 20 fill the microstructure 12 and bind to carboxyl groups 13 in the microstructure 12.

Referring to FIG. 2, the body 10 of the bipolar plate that has not reacted with the carboxylic acid solution is shown on the left, and the body 10 of the bipolar plate that has reacted with the carboxylic acid solution is shown on the right; it can be seen that the microstructure 12 has formed on the surface 11.

According to an embodiment of the present application, the body 10 of the bipolar plate is generally a steel sheet material, such as alloy steel; under the action of the carboxylic acid solution, slight corrosion will occur on the surface 11 of the body 10, thereby forming the microstructure 12 with a certain roughness. It should be pointed out that the present application does not place restrictions on the material of the bipolar plate; as long as it can be corroded by the carboxylic acid solution, it can serve as the material of the bipolar plate.

It should be pointed out that the embodiment above only provides a way of performing the manufacturing method of the present application directly on the body of the bipolar plate, but the present application is not limited to this. The manufacturing method of the present application may also be performed directly on a base material (e.g. a steel roll) of the bipolar plate, with the body of the bipolar plate being formed by a part of the base material. Thus, a carboxylic acid solution is used to treat a surface of the base material of the bipolar plate, such that a microstructure with a certain roughness forms on the surface; the surface is then rubbed with graphite, such that fragments of the graphite fill the microstructure and bind to carboxyl groups in the microstructure; and the bipolar plate is then made (e.g. by stamping, welding, etc.) from the base material on which a carbon coating has formed.

Carboxylic acids are organic acids, the molecules of which contain carboxyl groups (—COOH). In the present application, the carboxylic acid solution used may be an aqueous solution of at least one of formic acid, acetic acid, peroxy acids, ethanedioic acid (oxalic acid), malonic acid, benzoic acid, succinic acid, butenedioic acid, phthalic acid and a-naphthaleneacetic acid, and the weight percentage concentration of the carboxylic acid solution may be in the range of 5%-60%. It should be pointed out that the present application is not limited to the carboxylic acids listed above, and may use other carboxylic acids. Furthermore, other organic solvents may also be used to dissolve the carboxylic acid, in order to prepare different carboxylic acid solutions.

According to an embodiment of the present application, the carboxylic acid solution and the surface 11 of the body 10 (or base material) of the bipolar plate generally undergo a reaction for 10-200 seconds within a temperature range of 20° C.-70° C. In this way, it is possible to obtain a microstructure 12 that has suitable roughness, and the production process is easy to control. However, it should be pointed out that due to differences in the types and concentrations of carboxylic acid solutions used, there will be corresponding variation in the process parameters of the reaction between the carboxylic acid solution and the surface 11 of the body 10 (or base material) of the bipolar plate; this will not be described further here.

After treatment with the carboxylic acid solution, it is generally further necessary to dry the treated surface 11 of the body 10 (or base material) of the bipolar plate within a temperature range of 20° C.-100° C., so that moisture or other solvents volatilize, and carboxyl groups are left in the microstructure 12 formed.

It should be pointed out that the surface 11 of the body 10 of the bipolar plate is generally not a flat surface, instead having a large number of ribs (not shown), so that channels between adjacent ribs can be used to allow hydrogen and oxygen to flow through. Thus, for this type of bipolar plate, the manufacturing method of the present application further comprises a step of covering a part (e.g. a channel between ribs) of the surface 11 of the body 10 of the bipolar plate with a protective layer (not shown), before using the carboxylic acid solution to treat the surface 11 of the body 10 of the bipolar plate. Thus, the carboxylic acid solution only forms the microstructure on the ribs on the surface 11 of the body 10 of the bipolar plate. Furthermore, other parts on the surface 11 of the body 10 of the bipolar plate where no carbon coating 21 needs to be formed may also be covered with a protective layer. The protective layer may for example be one of polyimide, polyamide and polyester, but the present application is not limited to this.

In order to increase the attachment strength between the carbon coating 21 and the surface 11 of the body 10 (or base material) of the bipolar plate, the roughness of the treated surface 11 of the body 10 (or base material) of the bipolar plate is preferably greater than or equal to 0.1 microns, so that a suitable microstructure 12 can be formed.

According to an embodiment of the present application, the graphite 20 may be a natural graphite such as flake graphite, earthy graphite or lump graphite, or an artificial graphite such as monocrystalline graphite, polycrystalline graphite or pyrolitic graphite, etc.

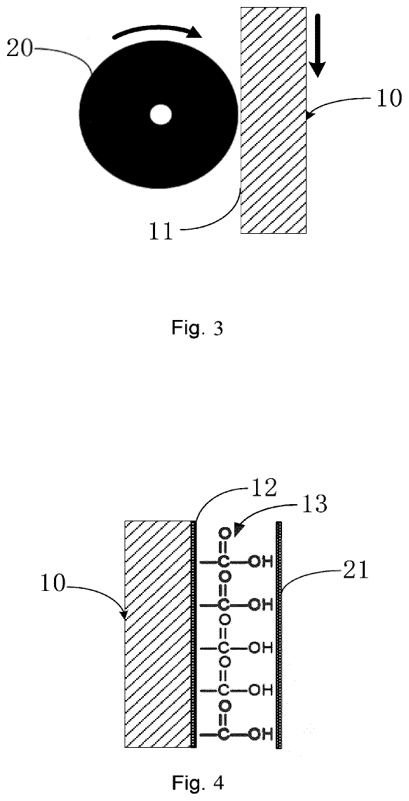

The graphite 20 may be made into one of a graphite block, a graphite rod and a graphite wheel, and the graphite 20 slides or rolls against the surface 11 of the body 10 (or base material) of the bipolar plate, so that fragments of the graphite 20 fill the microstructure 12 on the surface 11 of the body 10 (or base material) of the bipolar plate. Referring to FIG. 3, the graphite 20 (shown as a graphite wheel) rotates at high speed (as shown by the curved arrow) under the driving action of an electric motor and abuts the surface 11 of the body 10 (or base material) of the bipolar plate, while the body (or base material) of the bipolar plate is caused to undergo translation (as shown by the downward arrow); friction between the graphite wheel and the surface 11 of the body 10 (or base material) of the bipolar plate causes fragments of the graphite 20 to become embedded in the microstructure 12 formed on the surface 11 of the body 10 (or base material) of the bipolar plate, thereby forming the carbon coating 21, and binding to the carboxyl groups 13 in the microstructure 12 further increases the attachment strength. Although the use of graphite in the form of a graphite wheel is shown in FIG. 3, the present application may also employ other methods, such as sliding a graphite block on the surface of the body (or base material) of the bipolar plate, to form the carbon coating.

According to an embodiment of the present application, the thickness of the carbon coating formed may be within a range of 1-2000 microns.

It should be pointed out that although the formation of the carbon coating on only one surface of the body (or base material) of the bipolar plate has been disclosed in the drawings and the description above, the present application is not limited to this. The manufacturing method of the present application may be used to form the carbon coating on two surfaces of the body (or base material) of the bipolar plate.

Based on the manufacturing method described above, the present application further provides a bipolar plate for a fuel cell, the bipolar plate comprising a body 10 and a carbon coating 21, wherein a surface 11 of the body 10 has a microstructure 12 with a certain roughness that is formed by treatment with a carboxylic acid solution, and the carbon coating 21 is bound to the body 10 via carboxyl groups 13 in the microstructure 12, as shown in FIG. 4.

In addition, the present application further provides a fuel cell, wherein the fuel cell comprises the bipolar plate described above.

With the manufacturing method of the present application, the microstructure with a certain roughness can be produced by corrosion, using the carboxylic acid solution, on the surface of the body of the bipolar plate of the fuel cell, and graphite fragments are embedded in the microstructure to form the carbon coating. Thus, in addition to being attached to the body of the bipolar plate by becoming embedded in the microstructure, the graphite fragments can also further increase the strength of attachment to the body of the bipolar plate by binding to the carboxyl groups in the microstructure. At the same time, the manufacturing method of the present application can also reduce the manufacturing cost, and shorten the production time.

The present application has been described in detail above with reference to particular embodiments. However, the above description and the embodiments shown in the drawings should be understood to be exemplary, without limiting the present application. Those skilled in the art could make various changes or amendments thereto without departing from the spirit of the present application, and all such changes or amendments fall within the scope of the present application.

The invention claimed is:

1. A method for manufacturing a bipolar plate for a fuel cell, comprising:
using a carboxylic acid solution to treat a surface of a base material or body of the bipolar plate such that a microstructure with a certain roughness forms on the surface; and
rubbing the surface with graphite, such that fragments of the graphite fill the microstructure and bind to carboxyl groups in the microstructure.

2. The method as claimed in claim 1, wherein:
the carboxylic acid solution is an aqueous solution of at least one of oxalic acid, formic acid, acetic acid, peroxy acids, ethanedioic acid, malonic acid, benzoic acid, succinic acid, butenedioic acid, phthalic acid and a-naphthaleneacetic acid, and
the weight percentage concentration of the carboxylic acid solution is in the range of 5%-60%.

3. The method as claimed in claim 1, wherein the average value of the roughness of the surface is greater than or equal to 0.1 microns.

4. The method as claimed in claim 3, wherein:
the graphite is made into one of a graphite block, a graphite rod and a graphite wheel, and
the rubbing step includes sliding or rolling the graphite against the surface of the base material or body of the bipolar plate.

5. The method as claimed in claim 1, further comprising:
covering a part of the surface of the body of the bipolar plate with a protective layer before using the carboxylic acid solution to treat the surface of the body of the bipolar plate in order to expose a rib on the surface of the body of the bipolar plate; or
making the bipolar plate from the base material after using the carboxylic acid solution to treat the surface of the base material of the bipolar plate and rubbing with graphite.

6. The manufacturing method as claimed in claim 5, wherein the protective layer is one of polyimide, polyamide and polyester.

7. The method as claimed in claim 1, wherein the carboxylic acid solution and the surface of the base material or body of the bipolar plate undergo a reaction for 10-200 seconds within a temperature range of 20° C.-70° C.

8. The method as claimed in claim 1, further comprising:
drying the treated surface of the base material or body of the bipolar plate within a temperature range of 20° C.-100° C.

9. A bipolar plate for a fuel cell, comprising:
a body; and
a carbon coating,
wherein a surface of the body has a microstructure with a certain roughness that is formed by treatment with a carboxylic acid solution, and
wherein the carbon coating is bound to the body via carboxyl groups in the microstructure.
